(19) United States
(12) Patent Application Publication
(10) Pub. No.: US 2010/0137020 A1
(43) Pub. Date: Jun. 3, 2010

(54) COMMUNICATIONS DEVICE WITH MILLIMETER WAVE REMOTE CONTROL AND METHODS FOR USE THEREWITH

(75) Inventor: Ahmadreza (Reza) Rofougaran, Newport Coast, CA (US)

Correspondence Address: GARLICK HARRISON & MARKISON, P.O. BOX 160727, AUSTIN, TX, 78716-0727, US

(73) Assignee: Broadcom Corporation, Irvine, CA (US)

(21) Appl. No.: 12/326,200

(22) Filed: Dec. 2, 2008

(51) Int. Cl. H04M 1/00

(52) U.S. Cl. 455/550.1

(57) ABSTRACT

A communication device includes a wireless telephony transceiver for communicating first data with a wireless telephony network. One or more interface devices generate user data based on an action of a user. A processing module generates second data, based on the user data and based on first remote control configuration data corresponding to a first external device. A millimeter wave transceiver communicates the second data with the first external device via a millimeter wave communication path.

### CROSS REFERENCE TO RELATED APPLICATIONS

Not applicable

### BACKGROUND OF THE INVENTION

1. Technical Field of the Invention

This invention relates generally to mobile communication devices and more particularly to a wireless interface to peripheral devices.

2. Description of Related Art

Communication systems are known to support wireless and wire lined communications between wireless and/or wire lined communication devices. Such communication systems range from national and/or international cellular telephone systems to the Internet to point-to-point in-home wireless networks. Each type of communication system is constructed, and hence operates, in accordance with one or more communication standards. For instance, wireless communication systems may operate in accordance with one or more standards including, but not limited to, IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), radio frequency identification (RFID), Enhanced Data rates for GSM Evolution (EDGE), General Packet Radio Service (GPRS), and/or variations thereof.

Depending on the type of wireless communication system, a wireless communication device, such as a cellular telephone, two-way radio, personal digital assistant (PDA), personal computer (PC), laptop computer, home entertainment equipment, millimeter wave transceiver, RFID tag, et cetera communicates directly or indirectly with other wireless communication devices. For direct communications (also known as point-to-point communications), the participating wireless communication devices tune their receivers and transmitters to the same channel or channels (e.g., one of the plurality of radio frequency (RF) carriers of the wireless communication system or a particular RF frequency for some systems) and communicate over that channel(s). For indirect wireless communications, each wireless communication device communicates directly with an associated base station (e.g., for cellular services) and/or an associated access point (e.g., for an in-home or in-building wireless network) via an assigned channel. To complete a communication connection between the wireless communication devices, the associated base stations and/or associated access points communicate with each other directly, via a system controller, via the public switch telephone network, via the Internet, and/or via some other wide area network.

Many electronic devices operate in conjunction with a remote control. The remote control typically includes a plurality of buttons and an infrared transmitter for transmitting remote control data to the device to be controlled via an infrared link. Universal remote controls exist that include infrared remote control parameters for a plurality of devices and that can be programmed to operate with one or more particular devices.

The disadvantages of conventional approaches will be apparent to one skilled in the art when presented with the disclosure herein.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWING(S)

FIG. 1 is a schematic block diagram of an embodiment of a communication system in accordance with the present invention;

FIG. 2 is a schematic block diagram of an embodiment of another communication system in accordance with the present invention;

FIG. 3 is a pictorial diagram representation of a communication device and a plurality of remote devices in accordance with an embodiment of the present invention.

FIG. 4 is a block diagram representation of a communication device and electronic device in accordance with an embodiment of the present invention.

FIG. 5 is a schematic block diagram of an embodiment of an integrated circuit in accordance with the present invention;

FIG. 6 is a schematic block diagram of another embodiment of an integrated circuit in accordance with the present invention;

FIG. 7 is a schematic block diagram of an embodiment of an RF transceiver in accordance with the present invention;

FIG. 8 is a schematic block diagram of millimeter wave transceivers 77 and 120 in accordance with another embodiment of the present invention.

FIG. 9 is a pictorial representation of a screen display in accordance with an embodiment of the present invention.

FIG. 10 is a pictorial representation of a communication device and a wireless telephony network in accordance with an embodiment of the present invention.

FIG. 11 is a pictorial representation of a communication device and electronic device in accordance with another embodiment of the present invention.

FIG. 12 is a pictorial representation of a communication device and electronic device in accordance with another embodiment of the present invention.

FIG. 13 is a block diagram representation of a communication device and electronic device in accordance with another embodiment of the present invention.

FIG. 14 is a flow chart of an embodiment of a method in accordance with the present invention;

FIG. 15 is a flow chart of an embodiment of a method in accordance with the present invention;

FIG. 16 is a flow chart of an embodiment of a method in accordance with the present invention;

FIG. 17 is a flow chart of an embodiment of a method in accordance with the present invention;

FIG. 18 is a flow chart of an embodiment of a method in accordance with the present invention; and

FIG. 19 is a flow chart of an embodiment of a method in accordance with the present invention.

### DETAILED DESCRIPTION OF THE INVENTION

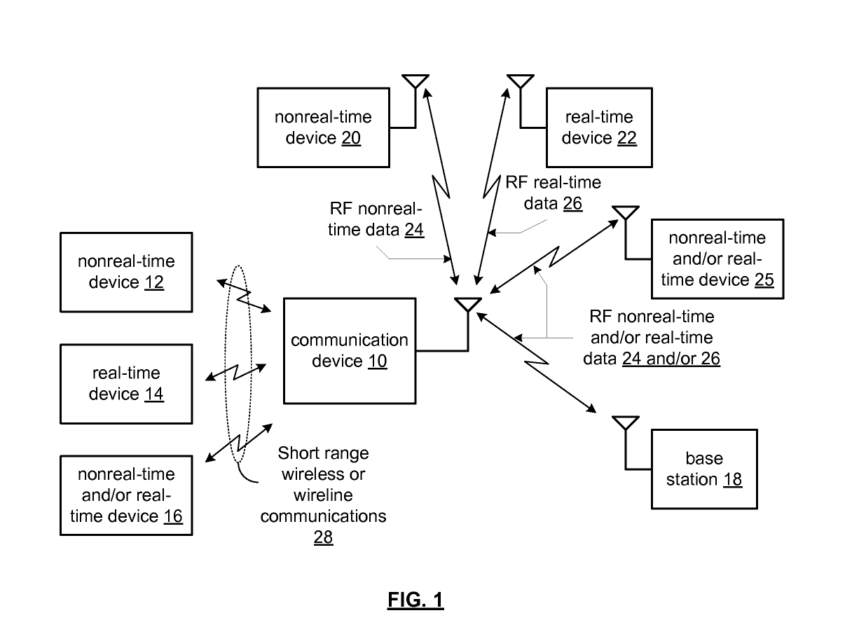

FIG. 1 is a schematic block diagram of an embodiment of a communication system in accordance with the present invention. In particular a communication system is shown that includes a communication device 10 that communicates real-time data 24 and/or non-real-time data 26 wirelessly with one or more other devices such as base station 18, non-real-time device 20, real-time device 22, and non-real-time and/or real-time device 25. In addition, communication device 10 can also communicate with non-real-time device 12, real-time device 14, non-real-time and/or real-time device 16 via short range wireless or wireline communications 28, such as a millimeter wave communications or a wireline coupling such as a Universal Serial Bus (USB) port, IEEE 1394 or Firewire port, RS-232 or other serial or parallel data communications port.

The wireless connection can communicate in accordance with a wireless network protocol such as IEEE 802.11, Bluetooth, Ultra-Wideband (UWB), WIMAX, or other wireless network protocol, a wireless telephony data/voice protocol such as Global System for Mobile Communications (GSM), General Packet Radio Service (GPRS), Enhanced Data Rates for Global Evolution (EDGE), Personal Communication Services (PCS), or other mobile wireless protocol or other wireless communication protocol, either standard or proprietary. Further, the wireless communication path can include separate transmit and receive paths that use separate carrier frequencies and/or separate frequency channels. Alternatively, a single frequency or frequency channel can be used to bi-directionally communicate data to and from the communication device 10.

Communication device 10 can be a mobile phone such as a cellular telephone, a personal digital assistant, communications device, personal computer, laptop computer, or other device that performs one or more functions that include communication of voice and/or data via short range wireless or wireline communications 28 and/or the wireless communication path. In an embodiment of the present invention, the real-time and non-real-time devices 18, 20, 22 and 24 can be personal computers, laptops, PDAs, a vehicle, mobile phones, such as cellular telephones, devices equipped with wireless local area network or Bluetooth transceivers, FM tuners, TV tuners, digital cameras, digital camcorders, or other devices that either produce, process or use audio, video signals or other data or communications. Real-time and non-real-time devices 12, 14 and 16 can be peripheral devices or user interface devices such as a mouse or other pointing device, a touch pad, keyboard, keypad, microphone, earphones, headsets and/or other peripheral devices, a host device such as a personal computer, another wireless communication device or a vehicle, such as an automobile, motorcycle or boat that can be coupled to communications device 10 via short range wireless or wireline communications 28.

In operation, the communication device includes one or more applications that operate based on user data, such as user data from a peripheral device or user interface device in communication with communications device 10. Examples of these application include voice communications such as standard telephony applications, voice-over-Internet Protocol (VoIP) applications, local gaming, Internet gaming, email, instant messaging, multimedia messaging, web browsing, audio/video recording, audio/video playback, audio/video downloading, playing of streaming audio/video, vehicle diagnostic applications, vehicle emergency applications, mapping, location and navigation applications, remote control applications for remotely controlling an electronic device, office applications such as databases, spreadsheets, word processing, presentation creation and processing and other voice and data applications. In conjunction with these applications, the real-time data 26 includes voice, audio, video and multimedia applications including Internet gaming, etc. The non-real-time data 24 includes text messaging, email, web browsing, file uploading and downloading, etc.

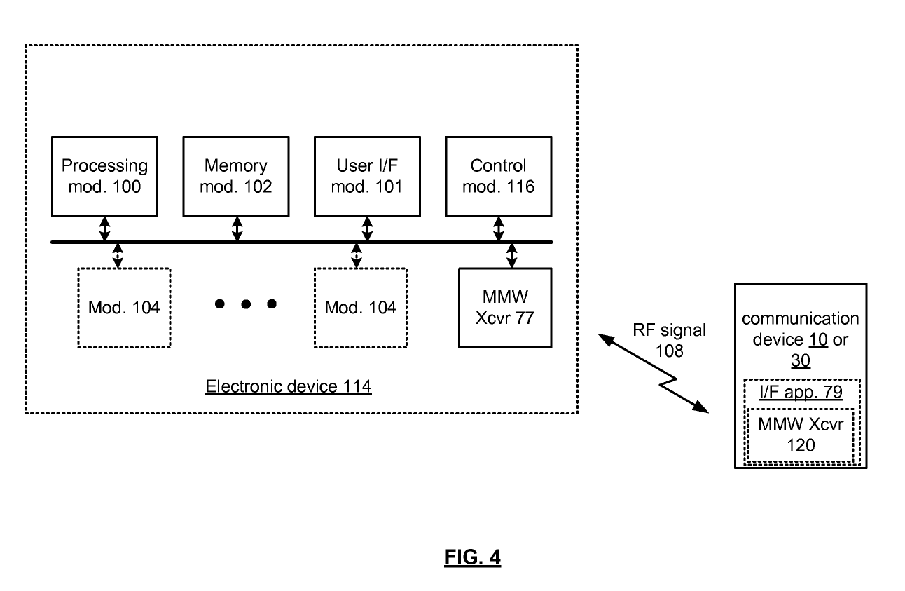

In an embodiment of the present invention, the communication device 10 includes a circuit, such as a combined voice, data and RF integrated circuit that includes one or more features or functions of the present invention. Such circuits shall be described in greater detail in association with FIGS. 4-19 that follow.

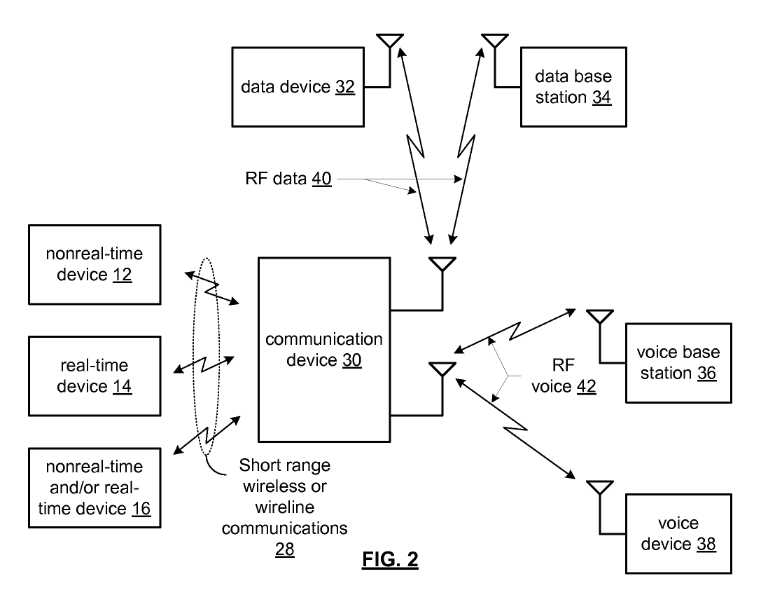

FIG. 2 is a schematic block diagram of an embodiment of another communication system in accordance with the present invention. In particular, FIG. 2 presents a communication system that includes many common elements of FIG. 1 that are referred to by common reference numerals. Communication device 30 is similar to communication device 10 and is capable of any of the applications, functions and features attributed to communication device 10, as discussed in conjunction with FIG. 1. However, communication device 30 includes two or more separate wireless transceivers for communicating, contemporaneously, via two or more wireless communication protocols with data device 32 and/or data base station 34 via RF data 40 and voice base station 36 and/or voice device 38 via RF voice signals 42.

In an embodiment of the present invention, the communication device 30 includes a circuit, such as a combined voice, data and RF integrated circuit that includes one or more features or functions of the present invention. Such circuits shall be described in greater detail in association with FIGS. 4-19 that follow.

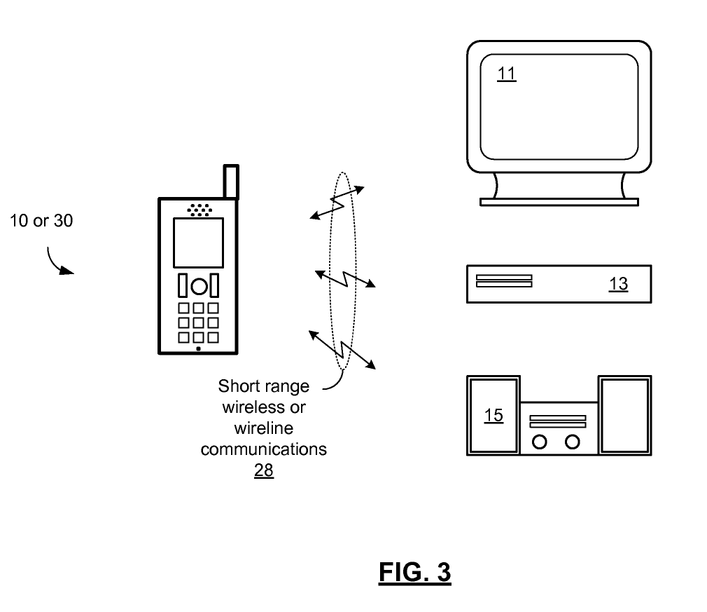

FIG. 3 is a pictorial diagram representation of a communication device and vehicle in accordance with an embodiment of the present invention. In particular, communications device 10 or 30 executes one or more of a plurality of applications including a remote control application for communicating via short range communications, such as short range wireless or wireline communications 28 with an electronic device, such as a television 11, video device 13 such as a set-top box, digital video recorder, digital video disc player, video cassette recorder or other video component, audio device 15, such as a tuner, receiver, home stereo system, personal audio player docking system, satellite radio system, high definition radio, home theatre system or other electronic device having a complementary remote control functionality.

In operation, communication device 10 or 30 can enter a remote control mode of operation by executing a remote control application. In this mode of operation, the communication device can select the device or devices that it wishes to control and configure itself for communication with this device or these devices. In particular, the communication device 10 or 30 selects the particular modulation, frequency band or channels, power levels, protocol parameters and data formats to convert actions of the user of communication device 10 or 30 to control data for transmission via short range wireless or wireline communications 28. This control data, when received by the electronic device, controls the operation of the device in a manner intended by the user.

In an embodiment of the present invention, the communication device 10 or 30 operates in a similar fashion to a universal remote control device to be configured for operation with one or more particular electronic devices, such as television 11, video device 13 and/or audio device 15. Once configured, the user interface of communication device 10 or 30, such as with dedicated keys, soft keys, touch screen, display prompts or other user interface features allows the user to indicate the particular remote control functions to be generated and then generates control data in response thereto. For instance, the user can select from an on-screen menu to control television 11 and then power-on the television, adjust the volume and change the channels through operation of one or more user interface devices of communication system 10 or 30.

The operation of communication device 10 or 30 in a remote control mode of operation along with the associated devices under control, including many optional features and function, will be discussed in greater detail in conjunction with FIGS. 4-19 that follow.

FIG. 4 is a block diagram representation of a communication device and vehicle in accordance with an embodiment of the present invention. In particular, a communication system is shown that includes communications device 10 or 30 and electronic device 114. In this embodiment, short range wireless or wireline communications 28 are carried via millimeter wave communication path.

Electronic device 114, such as TV 11, video device 13, audio device 15 or other electronic device, includes processing module 100, user interface module 101, memory module 102, control module 116, millimeter wave transceiver 77 and optionally one or more additional modules 104 for implementing additional functions and features unique to the particular type of device. For example, a DVD player would include a media player for navigating and playing digital video discs and for generating video signals in response thereto. In another example, a television would include one or more receivers for receiving analog and/or digital video signals, etc.

Millimeter wave transceiver 77 is coupled to send and/or receive an RF signal 108, such as a 60 GHz RF signal or other millimeter wave RF signal, with a complementary millimeter wave transceiver 120 of communications device 10 or 30 that operates in conjunction with an interface application 79, such as a remote control application. In an embodiment of the present invention, millimeter wave transceivers 77 and 120 function in a manner similar to traditional full-duplex transceivers. In another embodiment, in a similar fashion to a passive RFID tag, millimeter wave transceiver 120 converts energy from the RF signal 108 into a power signal for powering the millimeter wave transceiver 120. By the millimeter wave transceiver deriving power, in whole or in part, based on RF signal 108, communication device 10 or 30 can optionally be more portable, small and light. In this embodiment, millimeter wave transceiver 120 can convey the data back to the electronic device 114 by backscattering the RF signal 108.

Processing module 100, can include a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The associated memory may be a single memory device or a plurality of memory devices that are either on-chip or off-chip such as memory module 102. Such a memory device may be a read-only memory, random access memory, volatile memory, non-volatile memory, static memory, dynamic memory, flash memory, and/or any device that stores digital information. Note that when the processing module 100 implements one or more of its functions via a state machine, analog circuitry, digital circuitry, and/or logic circuitry, the associated memory storing the corresponding operational instructions for this circuitry is embedded with the circuitry comprising the state machine, analog circuitry, digital circuitry, and/or logic circuitry.

Control module 116 operates via hardware, software or firmware to process control data received via the millimeter wave transceiver 77 into control commands for controlling one or more functions of the electronic device 114. Further, control module 114 optionally stores remote control configuration data that can be transferred via the millimeter wave transceiver 77 to one or more associate remote control devices, such as communication device 10 or 30.

In one implementation, processing module 100 is a stand alone device that operates in conjunction with the other modules and systems shown in conjunction with electronic device 114, and to facilitate communication there between via the bus structure shown. In another embodiment, processing module serves as a central processor to implement one or more functions of the various modules and systems shown in conjunction with electronic device 114. In a further embodiment, the functionality of processing module 100 and memory module 102 can be distributed throughout one or more of other modules and systems shown in conjunction with electronic device 114. While a general bus architecture is shown, alternative bus architectures are likewise possible, that include additional buses and/or direct connectivity between the various modules and systems shown.

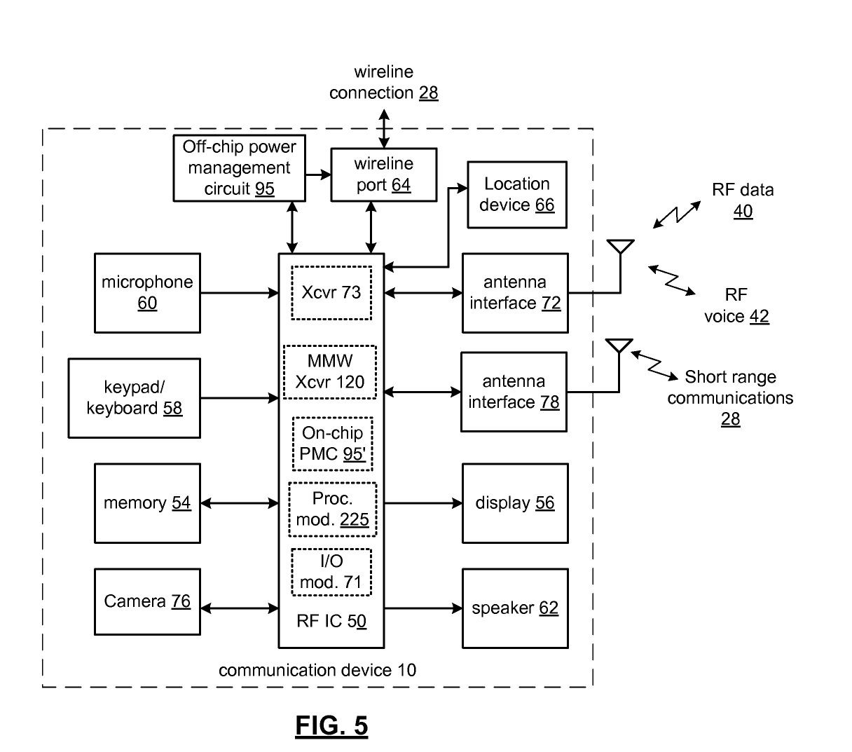

FIG. 5 is a schematic block diagram of an embodiment of an integrated circuit in accordance with the present invention. In particular, an RF integrated circuit (IC) 50 is shown that implements communication device 10 in conjunction with microphone 60, keypad/keyboard 58, memory 54, speaker 62, display 56, camera 76, antenna interface 52 and wireline port 64. In addition, RF IC 50 includes a transceiver 73 with RF and baseband modules for formatting and modulating data into RF real-time data 26 and non-real-time data 24 and transmitting this data via an antenna interface 72 and an antenna and millimeter wave transceiver 120 for communicating with an external device such as electronic device 114. Further, RF IC 50 includes an input/output module 71 with appropriate encoders and decoders for communicating via the wireline connection 28 via wireline port 64, an optional memory interface for communicating with off-chip memory 54, a codec for encoding voice signals from microphone 60 into digital voice signals, a keypad/keyboard interface for generating data from keypad/keyboard 58 in response to the actions of a user, a display driver for driving display 56, such as by rendering a color video signal, text, graphics, or other display data, and an audio driver such as an audio amplifier for driving speaker 62 and one or more other interfaces, such as for interfacing with the camera 76 or the other peripheral devices.

Off-chip power management circuit 95 includes one or more DC-DC converters, voltage regulators, current regulators or other power supplies for supplying the RF IC 50 and optionally the other components of communication device 10 and/or its peripheral devices with supply voltages and or currents (collectively power supply signals) that may be required to power these devices. Off-chip power management circuit 95 can operate from one or more batteries, line power and/or from other power sources, not shown. In particular, off-chip power management module can selectively supply power supply signals of different voltages, currents or current limits or with adjustable voltages, currents or current limits in response to power mode signals received from the RF IC 50. RF IC 50 optionally includes an on-chip power management circuit 95′ for replacing the off-chip power management circuit 95.

In an embodiment of the present invention, the RF IC 50 is a system on a chip integrated circuit that includes at least one processing device. Such a processing device, for instance, processing module 225, may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The associated memory may be a single memory device or a plurality of memory devices that are either on-chip or off-chip such as memory 54. Such a memory device may be a read-only memory, random access memory, volatile memory, non-volatile memory, static memory, dynamic memory, flash memory, and/or any device that stores digital information. Note that when the processing module 225 implements one or more of its functions via a state machine, analog circuitry, digital circuitry, and/or logic circuitry, the associated memory storing the corresponding operational instructions for this circuitry is embedded with the circuitry comprising the state machine, analog circuitry, digital circuitry, and/or logic circuitry.

In operation, the RF IC 50 executes operational instructions that implement one or more of the applications (real-time or non-real-time) attributed to communication devices 10 and 30 as discussed in conjunction with FIGS. 1-4. In particular, communication device 10 or 30, via at least one user interface device such as microphone 60, keypad/keyboard 58 and/or display 56, generates user data based on an action of a user. Such actions can be pressing a key, operation of a touch screen as part of a graphical user interface, voice commands or other actions of the user that can be identified and used in the generation of user data. Processing module 225 executes a remote control application for generating control data, based on the user data and based on remote control configuration data corresponding to the particular external device to be controlled. The millimeter wave transceiver 120 communicates the control data to the external device to be controlled via a millimeter wave communication path.

In an embodiment of the present invention, memory 54 stores a plurality of remote control configuration data corresponding to a plurality of external devices. In one mode of operation, memory 54 includes one or more data files corresponding to remote control configuration data a wide variety of electronic devices 114 that is sortable by device type, brand and model number. The user of communication device 10 or 30 can configure the device to control a particular set of electronic devices that he or she owns by identifying these devices through a selection procedure included in the remote control application.

For example, if a user of communication device 10 or 30 wishes to control his or her TV, DVD player, home theatre system and set top box, the user identifies these devices to the remote control application. In response, the remote control application retrieves the remote control configuration data corresponding to these devices from memory 54 and places them in one or more registers or otherwise flags this particular data for easy access. When a particular device, such as the TV, is to be controlled, the corresponding remote control configuration data for the TV is used to format outbound control data in accordance with the particular commands that the user has indicated via the user interface of the communication device 10 or 30. The control data can then be sent to the TV via short range communications 28.

In an embodiment of the present invention, the processing module 225, via the remote control application, determines if remote control configuration data is not stored in memory for a particular electronic device. In response, the remote control application can download the remote control configuration data required for one or more devices, either automatically when desired remote control configuration data is not stored in memory 54 or initiated based on the actions of the user. In one mode of operation, the processing module, via the remote control application, downloads desired remote control configuration data via the transceiver 73 from a server coupled to a data network such as the Internet.

In another embodiment, the processing module, via the remote control application, downloads the desired remote control configuration data via the millimeter wave communication path from the electronic device to be controlled. Referring back to FIG. 4, the memory module 102 stores remote control configuration data for the particular electronic device 114 that, in response to a request from communication device 10 or 30 received via RF signal 108, can be sent to the communication device 10 or 30. In this embodiment, the millimeter wave transceiver 120 of communication device 10 or 30 is configured in a default/universal mode of operation to communicate with devices such as millimeter wave transceiver 77. Additional remote control configuration data, such as the format for particular remote control commands and/or other remote control configuration data can be transferred to communication device 10 or 30 for use by the remote control application of processing module 225.

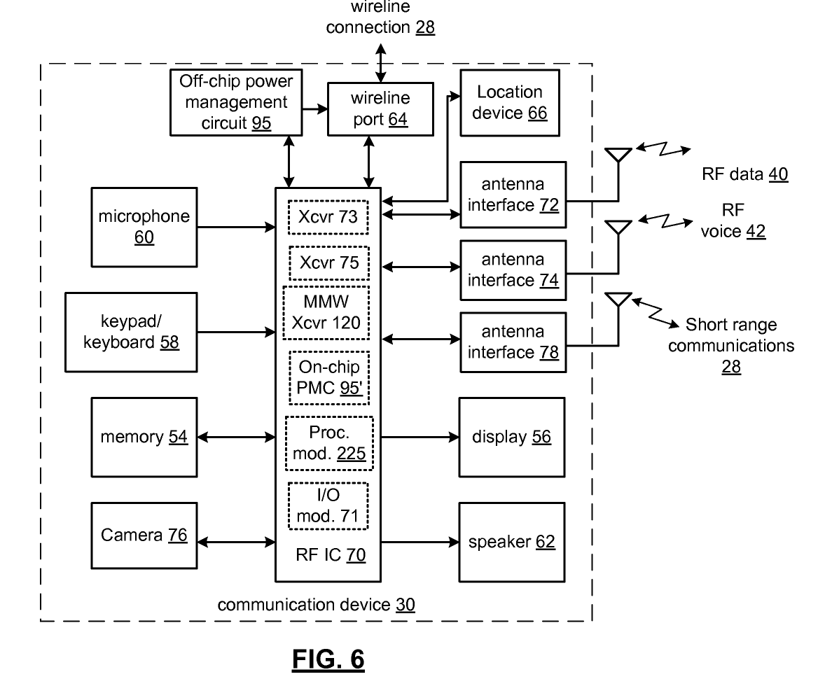

FIG. 6 is a schematic block diagram of another embodiment of an integrated circuit in accordance with the present invention. In particular, FIG. 6 presents a communication device 30 that includes many common elements of FIG. 5 that are referred to by common reference numerals. RF IC 70 is similar to RF IC 50 and is capable of any of the applications, functions and features attributed to RF IC 50 as discussed in conjunction with FIG. 5. However, RF IC 70 includes two separate wireless transceivers 73 and 75 for communicating, contemporaneously, via two or more wireless communication protocols via RF data 40 and RF voice signals 42.

In operation, the RF IC 70 executes operational instructions that implement one or more of the applications (real-time or non-real-time) attributed to communication device 10 or 30 as discussed in conjunction with FIGS. 1-5.

FIG. 7 is a schematic block diagram of an RF transceiver 125, such as transceiver 73, 75, 77 or 120 which may be incorporated in communication devices 10 and/or 30 or electronic device 114. The RF transceiver 125 includes an RF transmitter 129, an RF receiver 127 that operate in accordance with a wireless local area network protocol, a pico area network protocol, a wireless telephony protocol, a wireless data protocol, or other protocol. The RF receiver 127 includes a RF front end 140, a down conversion module 142, and a receiver processing module 144. The RF transmitter 129 includes a transmitter processing module 146, an up conversion module 148, and a radio transmitter front-end 150.

As shown, the receiver and transmitter are each coupled to an antenna through an off-chip antenna interface 171 and a diplexer (duplexer) 177, that couples the transmit signal 155 to the antenna to produce outbound RF signal 170 and couples inbound RF signal 152 to produce received signal 153. While a single antenna is represented, the receiver and transmitter may each employ separate antennas or share a multiple antenna structure that includes two or more antennas. In another embodiment, the receiver and transmitter may share a multiple input multiple output (MIMO) antenna structure that includes a plurality of antennas. Each antenna may be fixed, programmable, an antenna array or other antenna configuration. Accordingly, the antenna structure of the wireless transceiver may depend on the particular standard(s) to which the wireless transceiver is compliant and the applications thereof.

In operation, the transmitter receives outbound data 162 from processor 225 or other or other source via the transmitter processing module 146. The transmitter processing module 146 processes the outbound data 162 in accordance with a particular wireless communication standard (e.g., IEEE 802.11, Bluetooth, RFID, GSM, CDMA, et cetera) to produce baseband or low intermediate frequency (IF) transmit (TX) signals 164. The baseband or low IF TX signals 164 may be digital baseband signals (e.g., have a zero IF) or digital low IF signals, where the low IF typically will be in a frequency range of one hundred kilohertz to a few megahertz. Note that the processing performed by the transmitter processing module 146 includes, but is not limited to, scrambling, encoding, puncturing, mapping, modulation, and/or digital baseband to IF conversion. Further note that the transmitter processing module 146 may be implemented using a shared processing device, individual processing devices, or a plurality of processing devices and may further include memory. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory may be a single memory device or a plurality of memory devices. Such a memory device may be a read-only memory, random access memory, volatile memory, non-volatile memory, static memory, dynamic memory, flash memory, and/or any device that stores digital information. Note that when the processing module 146 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

The up conversion module 148 includes a digital-to-analog conversion (DAC) module, a filtering and/or gain module, and a mixing section. The DAC module converts the baseband or low IF TX signals 164 from the digital domain to the analog domain. The filtering and/or gain module filters and/or adjusts the gain of the analog signals prior to providing it to the mixing section. The mixing section converts the analog baseband or low IF signals into up converted signals 166 based on a transmitter local oscillation.

The radio transmitter front end 150 includes a power amplifier and may also include a transmit filter module. The power amplifier amplifies the up converted signals 166 to produce outbound RF signals 170, which may be filtered by the transmitter filter module, if included. The antenna structure transmits the outbound RF signals 170 to a targeted device such as a RF tag, base station, an access point and/or another wireless communication device via an antenna interface 171 coupled to an antenna that provides impedance matching and optional bandpass filtration.

The receiver receives inbound RF signals 152 via the antenna and off-chip antenna interface 171 that operates to process the inbound RF signal 152 into received signal 153 for the receiver front-end 140. In general, antenna interface 171 provides impedance matching of antenna to the RF front-end 140 and optional bandpass filtration of the inbound RF signal 152.

The down conversion module 70 includes a mixing section, an analog to digital conversion (ADC) module, and may also include a filtering and/or gain module. The mixing section converts the desired RF signal 154 into a down converted signal 156 that is based on a receiver local oscillation, such as an analog baseband or low IF signal. The ADC module converts the analog baseband or low IF signal into a digital baseband or low IF signal. The filtering and/or gain module high pass and/or low pass filters the digital baseband or low IF signal to produce a baseband or low IF signal 156. Note that the ordering of the ADC module and filtering and/or gain module may be switched, such that the filtering and/or gain module is an analog module.

The receiver processing module 144 processes the baseband or low IF signal 156 in accordance with a particular wireless communication standard (e.g., IEEE 802.11, Bluetooth, RFID, GSM, CDMA, et cetera) to produce inbound data 160. The processing performed by the receiver processing module 144 can include, but is not limited to, digital intermediate frequency to baseband conversion, demodulation, demapping, depuncturing, decoding, and/or descrambling. Note that the receiver processing modules 144 may be implemented using a shared processing device, individual processing devices, or a plurality of processing devices and may further include memory. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory may be a single memory device or a plurality of memory devices. Such a memory device may be a read-only memory, random access memory, volatile memory, non-volatile memory, static memory, dynamic memory, flash memory, and/or any device that stores digital information. Note that when the receiver processing module 144 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

When used in the implementation of millimeter wave transceiver 77, the RF front end 140, down conversion module 142, receiver processing module 144, radio transmitter front end 150, up conversion module 148 and/or transmitter processing module 146 can optionally be configured via control signals 141 from processing module to conform to the particular power level, frequency channel, frequency band, modulation, protocol, and other format in accordance with the particular remote control configuration data corresponding to a particular electronic device 114. In particular, particular frequency channels, and/or frequency bands can be selected by adjusting a local oscillation frequency, filter bandwidth, etc. under control of control signals 141. Different modulations and protocols can be implemented in receiver processing module 144 and/or transmitter processing module 146 under control of control signals 141.

FIG. 8 is a schematic block diagram of millimeter wave transceivers 77 and 120 in accordance with another embodiment of the present invention. As shown, millimeter wave transceiver 77 includes a protocol processing module 340, an encoding module 342, an RF front-end 346, a digitization module 348, a predecoding module 350 and a decoding module 352, all of which together form components of the millimeter wave transceiver 77. Millimeter wave transceiver 77 optionally includes a digital-to-analog converter (DAC) 344.

The protocol processing module 340 is operably coupled to prepare data for encoding in accordance with a particular RFID standardized protocol. In an exemplary embodiment, the protocol processing module 340 is programmed with multiple RFID standardized protocols or other protocols to enable the millimeter wave transceiver 77 to communicate with any communication device 10 or 30, regardless of the particular protocol associated with the device. In this embodiment, the protocol processing module 340 operates to program filters and other components of the encoding module 342, decoding module 352, pre-decoding module 350 and RF front end 346 in accordance with the particular RFID standardized protocol of the communication devices currently communicating with the millimeter wave transceiver 77. However, if communication device 10 or 30 each operate in accordance with a single protocol, this flexibility can be omitted.

In operation, once the particular protocol has been selected for communication with one or more communication device 10 or 30, the protocol processing module 340 generates and provides digital data to be communicated to the millimeter wave transceiver 120 to the encoding module 342 for encoding in accordance with the selected protocol. This digital data can include commands to power up the millimeter wave transceiver 120, to read user data or other commands or data used by the communication device in association with its operation. By way of example, but not limitation, the RFID protocols may include one or more line encoding schemes, such as Manchester encoding, FM0 encoding, FM1 encoding, etc. Thereafter, in the embodiment shown, the digitally encoded data is provided to the digital-to-analog converter 344 which converts the digitally encoded data into an analog signal. The RF front-end 346 modulates the analog signal to produce an RF signal at a particular carrier frequency that is transmitted via antenna 360 to one or more electronic devices 110.

The RF front-end 346 further includes transmit blocking capabilities such that the energy of the transmitted RF signal does not substantially interfere with the receiving of a back-scattered or other RF signal received from one or more electronic devices via the antenna 360. Upon receiving an RF signal from one or more communications devices, the RF front-end 346 converts the received RF signal into a baseband signal. The digitization module 348, which may be a limiting module or an analog-to-digital converter, converts the received baseband signal into a digital signal. The predecoding module 350 converts the digital signal into an encoded signal in accordance with the particular RFID protocol being utilized. The encoded data is provided to the decoding module 352, which recaptures data therefrom in accordance with the particular encoding scheme of the selected RFID protocol. The protocol processing module 340 processes the recovered data and provides the recovered data to the electronic device 114 for further processing.

The processing module 340 may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module may have an associated memory element, which may be a single memory device, a plurality of memory devices, and/or embedded circuitry of the processing module. Such a memory device may be a read-only memory, random access memory, volatile memory, non-volatile memory, static memory, dynamic memory, flash memory, cache memory, and/or any device that stores digital information. Note that when the processing module 40 implements one or more of its functions via a state machine, analog circuitry, digital circuitry, and/or logic circuitry, the memory element storing the corresponding operational instructions may be embedded within, or external to, the circuitry comprising the state machine, analog circuitry, digital circuitry, and/or logic circuitry.

Millimeter wave transceiver 120 includes a power generating circuit 240, an oscillation module 244, a processing module 246, an oscillation calibration module 248, a comparator 250, an envelope detection module 252, a capacitor C1, and a transistor T1. The oscillation module 244, the processing module 246, the oscillation calibration module 248, the comparator 250, and the envelope detection module 252 may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. One or more of the modules 244, 246, 248, 250, 252 may have an associated memory element, which may be a single memory device, a plurality of memory devices, and/or embedded circuitry of the module. Such a memory device may be a read-only memory, random access memory, volatile memory, non-volatile memory, static memory, dynamic memory, flash memory, cache memory, and/or any device that stores digital information. Note that when the modules 244, 246, 248, 250, 252 implement one or more of their functions via a state machine, analog circuitry, digital circuitry, and/or logic circuitry, the memory element storing the corresponding operational instructions may be embedded within, or external to, the circuitry comprising the state machine, analog circuitry, digital circuitry, and/or logic circuitry.

In operation, the power generating circuit 240 generates a supply voltage (V_{DD}) from a radio frequency (RF) signal that is received via antenna 254. The power generating circuit 240 stores the supply voltage V_{DD} in capacitor C1 and provides it to modules 244, 246, 248, 250, 252.

When the supply voltage V_{DD} is present, the envelope detection module 252 determines an envelope of the RF signal, which includes a DC component corresponding to the supply voltage V_{DD}. In one embodiment, the RF signal is an amplitude modulation signal, where the envelope of the RF signal includes transmitted data. The envelope detection module 252 provides an envelope signal to the comparator 250. The comparator 250 compares the envelope signal with a threshold to produce a stream of recovered data.

The oscillation module 244, which may be a ring oscillator, crystal oscillator, or timing circuit, generates one or more clock signals that have a rate corresponding to the rate of the RF signal in accordance with an oscillation feedback signal. For instance, if the RF signal is a 60 GHz MHz signal, the rate of the clock signals will be n*60 GHz, where “n” is equal to or greater than 1.

The oscillation calibration module 248 produces the oscillation feedback signal from a clock signal of the one or more clock signals and the stream of recovered data. In general, the oscillation calibration module 248 compares the rate of the clock signal with the rate of the stream of recovered data. Based on this comparison, the oscillation calibration module 248 generates the oscillation feedback to indicate to the oscillation module 244 to maintain the current rate, speed up the current rate, or slow down the current rate.

The processing module 246 receives the stream of recovered data and a clock signal of the one or more clock signals. The processing module 246 interprets the stream of recovered data to determine a command or commands contained therein. The command may be to store data, update data, reply with stored data, verify command compliance, read user data, an acknowledgement, etc. If the command(s) requires a response, the processing module 246 provides a signal to the transistor T1 at a rate corresponding to the RF signal. The signal toggles transistor T1 on and off to generate an RF response signal that is transmitted via the antenna. In one embodiment, the millimeter wave transceiver 120 utilizes a back-scattering RF communication to send data that includes user data.

The millimeter wave transceiver 120 may further include a current reference (not shown) that provides one or more reference, or bias currents to the oscillation module 244, the oscillation calibration module 248, the envelope detection module 252, and the comparator 250. The bias current may be adjusted to provide a desired level of biasing for each of the modules 244, 248, 250, and 252.

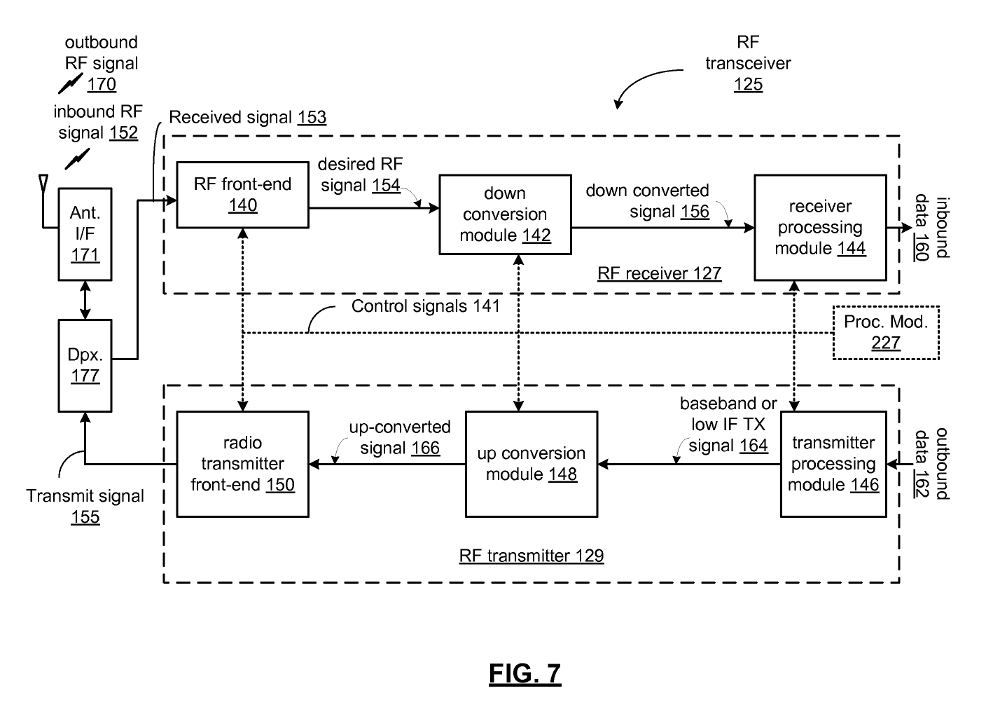

FIG. 9 is a pictorial representation of a screen display in accordance with an embodiment of the present invention. A screen display 370 is shown as part of a graphical user interface implemented by communication device 10 or 30 and in particular a display, such as display 56. In particular, an example remote control configuration screen is shown where the user is entering information on a particular electronic device to be configured, in this case a Cony brand television. As shown, the user has been prompted to enter, and has entered in corresponding text boxes, the device type, brand, and model number. The user has also assigned a device name, in this case “B's TV” that can be used as a shorthand to refer to this device in conjunction with the graphical user interface.

As previously discussed, the communication device can have stored in memory configuration data from a plurality of devices that are either prestored in the device, or downloaded as a group in conjunction with the loading or updating of a remote control application of that is downloaded to the device from a server, such as from the Internet. If one or more sets of remote control configuration data corresponding to a plurality of electronic devices are stored in the communication device 10 or 30, the device can search the stored remote configuration, such as by device type, brand, and/or model number to determine if corresponding remote control configuration data is stored. If no match is found, as indicated in screen display 370, the user can be given the option to download the remote control configuration data, and optionally in a subsequent screen display, not shown, the user can designate the download source, the network or communication path to be used, etc.

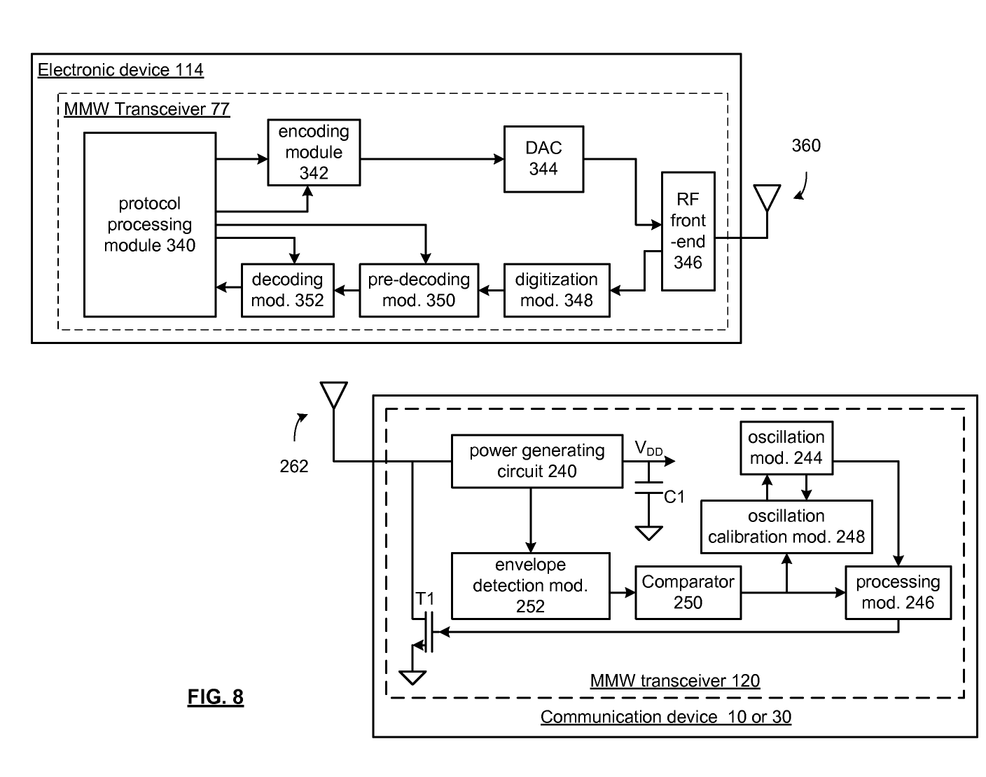

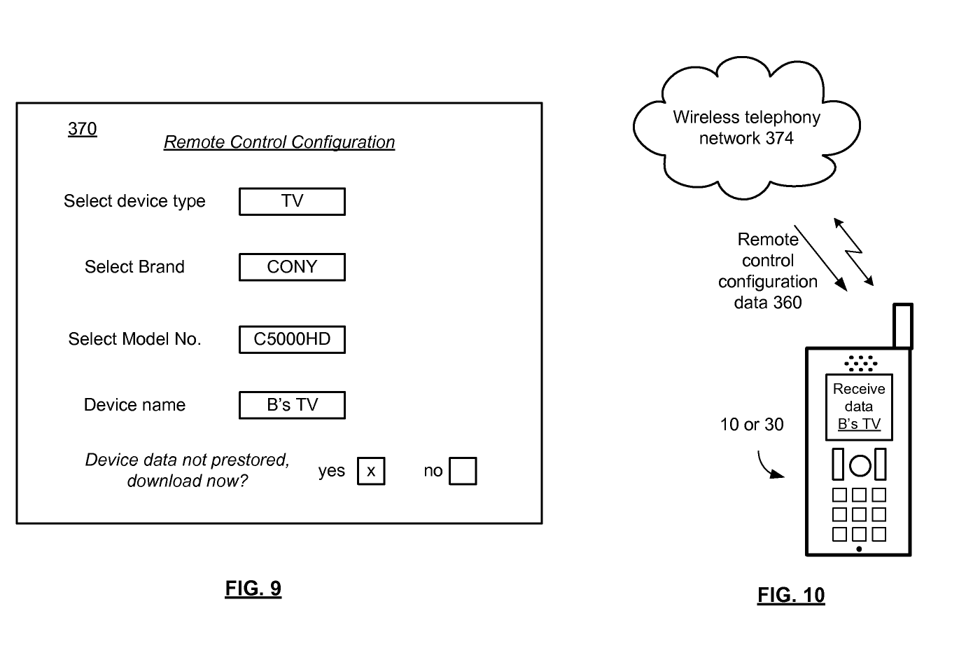

FIG. 10 is a pictorial representation of a communication device and a wireless telephony network in accordance with an embodiment of the present invention. In particular, communication device 10 or 30 is shown in communication with wireless telephony network 374 to download remote control configuration data 360 corresponding to one or more electronic devices from a network attached source such as a server attached to a local area network, a server attached to the Internet or from another source in communication with transceiver 73 or 75. As discussed in conjunction with FIG. 9, remote control configuration data 360 can be downloaded as a group in conjunction with the loading or updating of a remote control application of that is downloaded to the device from a server, such as from the Internet. In addition, remote control configuration data 360 can be downloaded as a group in a separate transaction. Further, remote control configuration data 360 can be downloaded on a single device basis at the request or initiation of a user of communication device 10 or 30 or automatically initiated during a set-up of communication device 10 or 30 to act as a remote control device for a particular electronic device.

FIG. 11 is a pictorial representation of a communication device and electronic device in accordance with another embodiment of the present invention. In particular, communication device 10 or 30 is shown in communication with a particular electronic device, in this case TV 11, to download remote control configuration data 360 corresponding to this particular device, that is stored in a memory of the device, such as memory 102. Remote control configuration data 360 can be downloaded via a millimeter wave communication path between wireless transceivers 77 and 120 at the request or initiation of a user of communication device 10 or 30 or automatically initiated during a set-up of communication device 10 or 30 to act as a remote control device for a particular electronic device, such as TV 11.

FIG. 12 is a pictorial representation of a communication device and electronic device in accordance with another embodiment of the present invention. In particular, communication device 10 or 30, via at least one user interface device such as microphone 60, keypad/keyboard 58 and/or display 56, generates user data based on an action of a user. Such actions can be pressing a key, operation of a touch screen as part of a graphical user interface, voice commands or other actions of the user that can be identified and used in the generation of user data. Processing module 225 executes a remote control application for generating control data 362, based on the user data and based on remote control configuration data corresponding to the particular external device to be controlled. The millimeter wave transceiver 120 communicates the second data to the external device to be controlled via a millimeter wave communication path, such as via RF signal 108. In the example shown, the user has taken action to issue a power on command to TV 11. In response, control data 362 is carried by RF signal 108 to TV 11 to implement this command and power on the television.

FIG. 13 is a block diagram representation of a communication device and electronic device in accordance with another embodiment of the present invention. In particular, a communication system is shown that includes communications device 10 or 30 and electronic device 114 in an embodiment that includes many similar elements to the embodiment of FIG. 4 that are referred to by common reference numerals. In addition, the electronic device 114 includes a docking interface 118 that can be coupled to a complementary docking interface 117 of communication device 10 or 30. In particular, docking interface 118 can be implemented via a plug and socket or other wireline connection such as the wireline connection of short range wireless or wireline connection 28. In particular this wireline connection can be implemented via a Universal Serial Bus (USB) port, IEEE 1394 or Firewire port, RS-232 or other serial or parallel data communications port. This wireline connection can be used in place of the millimeter wave communication path between millimeter wave transceivers 77 and 120, to facilitate the transfer of remote device configuration data 360.

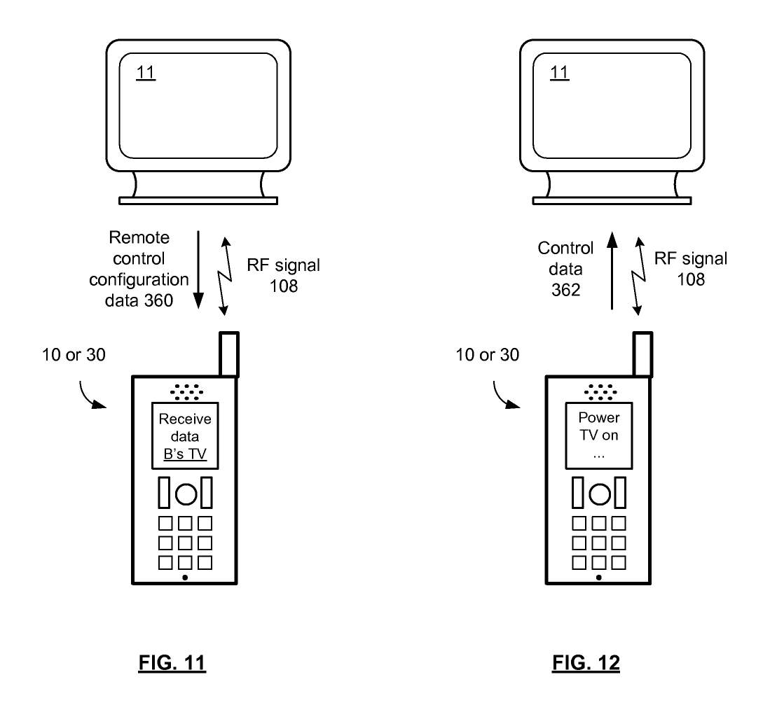

FIG. 14 is a flowchart representation of a method in accordance with an embodiment of the present invention. In particular a method is shown for use in conjunction with one or more functions and features discussed in conjunction with FIGS. 1-13. In step 400, first data is communicated with a wireless telephony network. In step 402, user data is generated based on an action of a user. In step 404, second data is generated, based on the user data and based on first remote control configuration data corresponding to a first external device. In step 406, the second data is communicated with the first external device via a millimeter wave communication path, such as a millimeter wave communication path that operates in a 60 GHz frequency band.

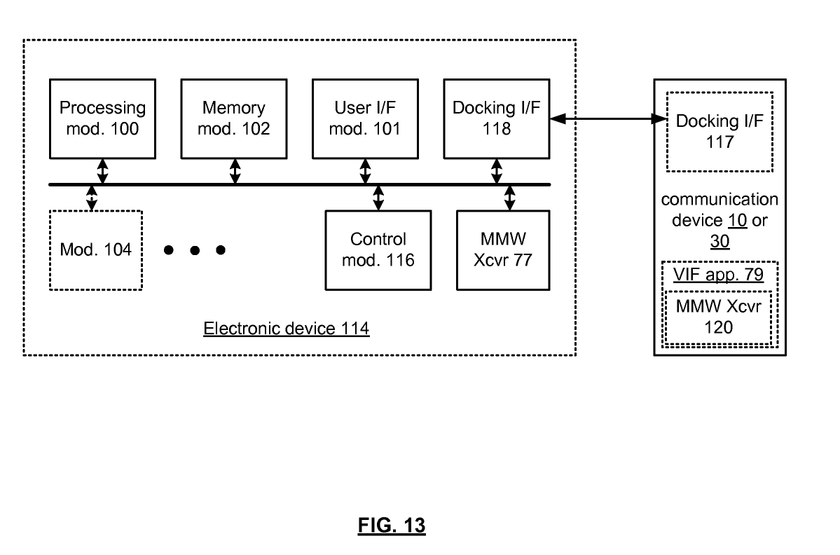

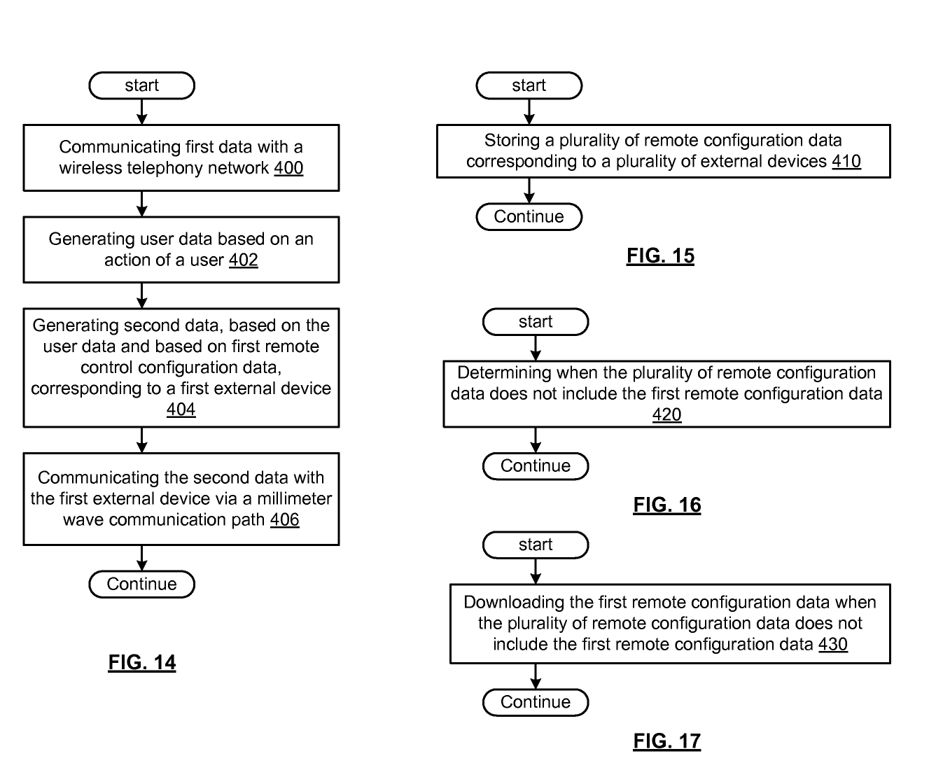

FIG. 15 is a flowchart representation of a method in accordance with an embodiment of the present invention. In particular a method is shown for use in conjunction with one or more functions and features discussed in conjunction with FIGS. 1-14. In step 410, a plurality of remote control configuration data are stored, corresponding to a plurality of external devices. In an embodiment of the present invention, the plurality of remote control configuration data includes the first remote control configuration data and the plurality of external devices includes the first external device.

FIG. 16 is a flowchart representation of a method in accordance with an embodiment of the present invention. In particular a method is shown for use in conjunction with one or more functions and features discussed in conjunction with FIGS. 1-15. In step 420, the method determines when the plurality of remote control configuration data does not include the first remote control configuration data.

FIG. 17 is a flowchart representation of a method in accordance with an embodiment of the present invention. In particular a method is shown for use in conjunction with one or more functions and features discussed in conjunction with FIGS. 1-16. In step 430, the first remote control configuration data is downloaded when the plurality of remote control configuration data does not include the first remote control configuration data. In an embodiment of the present invention, step 430 is automatically initiated when the plurality of remote control configuration data does not include the first remote control configuration data. Alternatively, step 430 is initiated based on the actions of the user.

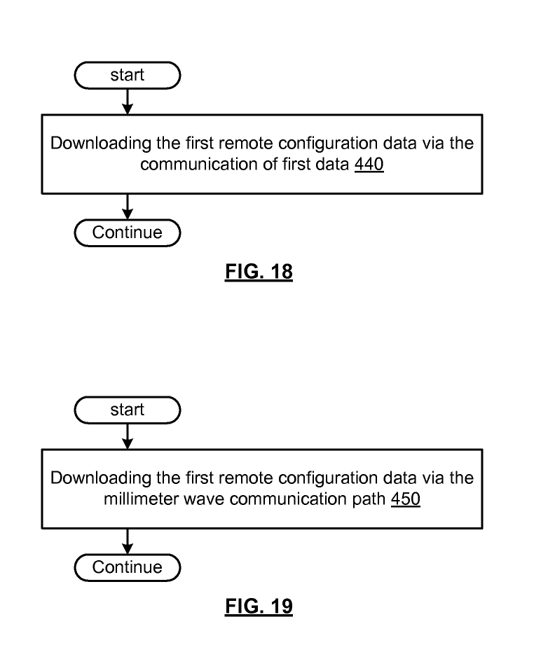

FIG. 18 is a flowchart representation of a method in accordance with an embodiment of the present invention. In particular a method is shown for use in conjunction with one or more functions and features discussed in conjunction with FIGS. 1-17. In step 440, the first remote control configuration data is downloaded via the communication of first data.

FIG. 19 is a flowchart representation of a method in accordance with an embodiment of the present invention. In particular a method is shown for use in conjunction with one or more functions and features discussed in conjunction with FIGS. 1-18. In step 450, the first remote control configuration data is downloaded via the millimeter wave communication path.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” and/or includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

What is claimed is:

1. A communication device comprising:
a wireless telephony transceiver for communicating first data with a wireless telephony network;
at least one user interface device for generating user data based on an action of a user;
a processing module, coupled to the at least one user interface device, for generating second data, based on the user data and based on first remote control configuration data corresponding to a first external device; and
a millimeter wave transceiver, coupled to the processing module, for communicating the second data with the first external device via a millimeter wave communication path.

2. The communication device of claim 1 further comprising:
a memory for storing a plurality of remote control configuration data corresponding to a plurality of external devices.

3. The communication device of claim 2 wherein the plurality of remote control configuration data includes the first remote control configuration data and the plurality of external devices includes the first external device.

4. The communication device of claim 2 wherein processing module determines when the plurality of remote control configuration data does not include the first remote control configuration data.

5. The communication device of claim 4 wherein the processing module downloads the first remote control configuration data, when the plurality of remote control configuration data does not include the first remote control configuration data.

6. The communication device of claim 5 wherein the processing module automatically initiates the download of the first remote control configuration data, when the plurality of remote control configuration data does not include the first remote control configuration data.

7. The communication device of claim 5 wherein the processing module initiates the download of the first remote control configuration data based on the actions of the user.

8. The communication device of claim 1 wherein the processing module downloads the first remote control configuration data via the communication of first data.

9. The communication device of claim 1 wherein the processing module downloads the first remote control configuration data via the millimeter wave communication path.

10. The communication device of claim 1 wherein the millimeter wave communication path operates in a 60 GHz frequency band.

11. A method for use in a communication device, the method comprising:
communicating first data with a wireless telephony network;
generating user data based on anaction of a user;
generating second data, based on the user data and based on first remote control configuration data corresponding to a first external device; and
communicating the second data with the first external device via a millimeter wave communication path.

12. The method of claim 11 further comprising:
storing a plurality of remote control configuration data corresponding to a plurality of external devices.

13. The method of claim 12 wherein the plurality of remote control configuration data includes the first remote control configuration data and the plurality of external devices includes the first external device.

14. The method of claim 12 further comprising:
determining when the plurality of remote control configuration data does not include the first remote control configuration data.

15. The method of claim 14 further comprising;
downloading the first remote control configuration data when the plurality of remote control configuration data does not include the first remote control configuration data.

16. The method of claim 15 wherein the downloading of the first remote control configuration data is automatically initiated when the plurality of remote control configuration data does not include the first remote control configuration data.

17. The method of claim 15 wherein the downloading of the first remote control configuration data is initiated based on the actions of the user.

18. The method of claim 11 further comprising:
downloading the first remote control configuration data via the communication of first data.

19. The method of claim 11 further comprising:
downloading the first remote control configuration data via the millimeter wave communication path.

20. The method of claim 11 wherein the millimeter wave communication path operates in a 60 GHz frequency band.
